(19) United States
(12) Patent Application Publication
(10) Pub. No.: US 2008/0094527 A1
(43) Pub. Date: Apr. 24, 2008

(54) Systems and methods for reducing defects during assembly of rear projection TV screens

(76) Inventors: Jose Daniel Barocio Montemayor, Tijuana (MX); Jesus Enrique Leal Ramos, Tijuana (MX); Oswaldo Cuen Tellez, Tijuana (MX); Judith Amaral Sanchez, Tijuana (MX); Horman Armando Millan Sanchez, Tijuana (MX)

Correspondence Address: ROGITZ & ASSOCIATES, 750 B STREET, SUITE 3120, SAN DIEGO, CA, 92101, US

(21) Appl. No.: 11/707,852

(22) Filed: Feb. 16, 2007

Related U.S. Application Data
(60) Provisional application No. 60/854,302, filed on Oct. 24, 2006.

(51) Int. Cl. H04N 5/74

(52) U.S. Cl. 348/779; 348/E05.138

(57) ABSTRACT

Systems and methods for reducing defects during assembly of rear projection TV screens by using direct high intensity light characterized and classified with spectroscopy analysis to identify contaminants in diffusion plates, and then controlling air flow to reduce or eliminate the contaminants.

This application claims priority from U.S. provisional patent application Ser. No. 60/854,302, filed Oct. 24, 2006.

### I. FIELD OF THE INVENTION

The present invention relates generally to reducing defects during assembly of rear projection TV screens.

### II. BACKGROUND OF THE INVENTION

In a rear-projection television system, a video image is generated by an optical engine and projected through a mirror toward a compound screen. Rear projection screens are used in flat screen digital TVs. Such a screen may include two diffusion plates, namely, a Fresnel lens plate and a lenticular lens plate that may be made of acrylic and that can be joined together by, e.g., taping in the border of the screen.

In the above-mentioned screen the purpose of the Fresnel lens is to cause the ray bundles to converge to a point approximately where a viewer would be located so that the viewer sees the entire image at once. On the other hand, the purpose of the lenticular lens is to broaden the ray bundles to wide enough angles so that the image is visible to a large audience, not just to a single observer in a fixed position.

As understood herein, such screens require special precautions to avoid damage during production. For example, as the screen bends due to temperature or humidity changes, the separation between the two lens plates can increase, especially in the center. Moreover, in areas where the two lens plate contact each other, they can rub against each other and cause visible damage. This latter concern is particularly acute if a hard particle is trapped between the optical surfaces during the assembly process, because of the risk that the particle will abrade, scratch, or otherwise degrade one of the lens plates. Additionally, contaminants on the plates undesirably scatter light and catalyze damage to the optical surfaces.

With these recognitions in mind, the present invention not only understands that it is important to minimize and indeed if possible entirely eliminate contaminants on rear projection screens, but that as part of doing so, it would be advantageous to identify the presence of the particles and/or remove them in the least harmful way possible and/or identify the composition of the particles to that their source may be identified and eliminated.

### SUMMARY OF THE INVENTION

A method is disclosed for making a rear projection TV screen. Prior to engaging the screen with a TV assembly to be vended, the screen is illuminated using inspection light, and the inspection light is directed onto the screen to identify contaminants thereon for removal. The screen is then engaged with a TV assembly to be vended.

The method may include establishing air flow in an assembly room in which the screen is disposed to reduce the potential for contaminants to rest on the screen. High intensity light can be used to illuminate the screen.

In one intended implementation, the screen includes first and second lens plates positioned substantially flush against each other. The first lens plate may be a lenticular lens plate and the second lens plate may be a Fresnel lens plate. Spectroscopic analysis of the inspection light can be used to identify contaminants on the screen.

In another aspect, a method for reducing contamination of TV screens during TV production in a facility includes, prior to engaging a TV screen with a TV assembly, illuminating the screen with light. The method then includes inspecting the illuminated screen to identify contaminants, analyzing a contaminant for composition, and correlating the composition to a source of contaminants. Corrective action is then taken that is related to the source of contaminants to reduce the risk of contamination of TV screens in the facility.

In another aspect, a TV production facility includes an assembly table configured for juxtaposing first and second TV lens plates. A ventilation unit is disposed directly vertically above the table, and a vertically-oriented barrier depends down from the room's ceiling and is spaced laterally beyond the ventilation unit. If desired, the barrier may be cylindrical and may surround the ventilation unit, which can be a fan that blows air past the table and toward an exhaust port.

In some embodiments, corner pads may be provided on respective corners of the table. The lens plates rest on the corner pads. Each pad can include a central cavity located such that when a lens plate is positioned on the table, respective corners of the plate are disposed on respective pads without covering the cavities of the pads. The pads ensure alignment of the plates and prevent movement of the plate, and because the corner of the plate is disposed in the cavity and thus does not contact any structure, the risk of damage to the corner is reduced.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting rear projection TV, showing the screen in schematically in cross-section with portions cut away for clarity;

FIG. 2 is a block diagram of a system for identifying whether particles are undesirably trapped on a screen;

FIG. 3 is a table showing particular illumination types for objects and applications;

FIG. 4 is a table showing a correlation between contaminant compositions and possible sources;

FIG. 5 is a top view of a non-limiting screen assembly facility;

FIG. 6 is a side view of the facility shown in FIG. 5; and

FIG. 7 is a top view of the screen resting on corner pads in the facility shown in FIG. 5, along with a detail of one of the pads.

### DETAILED DESCRIPTION OF THE PREFERRED EMBODIMENT

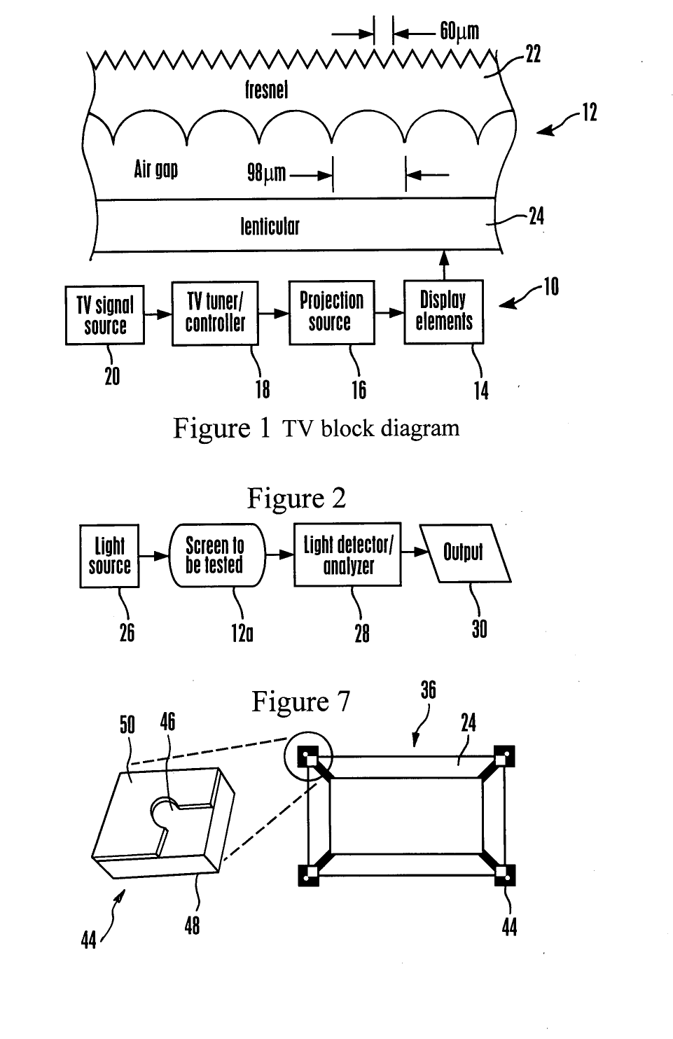

Referring initially to FIG. 1, a TV is shown, generally designated 10, that has a viewable screen 12 that can cover display elements 14 such as pixels or other elements (including elements energizable by raster scanning) in accordance with principles known in the art. In non-limiting implementations the display elements 14 may be actuated by a projection light source 16 within the TV that in turn is controlled by a TV tuner/display controller or driver circuit 18 to display video from a TV signal source 20 that may be, without limitation, an antenna, a cable connection, a set-top box receiving signals from a cable or satellite TV head end, etc.

In the preferred embodiment shown in FIG. 1, the screen 12 has two lens plates 22, 24. The first lens plate 22 may be a lenticular lens plate with a lens pitch of, e.g., ninety eight micrometers as shown, while the second lens plate 24 may be a Fresnel lens plate with a lens pitch of, e.g., sixty micrometers. In the embodiment shown in FIG. 1 the TV 10 is a rear projection TV that includes a multi-plate screen 12 such as is commercially exemplified by Sony's Wega™ TV, it being understood that present principles are not necessarily restricted to rear projection multi-plate screen TVs.

As recognized herein, the screen 12 of the TV 10 shown in FIG. 1, when assembled in accordance with principles below, typically is less contaminated than conventional screens. Either individually or after being juxtaposed together the plates 22, 24 may be inspected visually by illuminating them with light and observing whether the inspection light reveals any contaminants, so that the contaminants may be removed as discussed further below.

In addition to visual inspection the light may be collected and analyzed using the non-limiting system shown in FIG. 2 either on-site or in a specialized laboratory, in which an illuminating light source 26 directs inspection light against a screen 12a (or a sample thereof) that has been determined to be damaged. To characterize the type of damage to aid in defect reduction, light from the screen (or sample thereof) is received by a light detector/analyzer assembly 28 including but not limited to a scanning electron microscope (SEM) as described more fully below and then an analysis output is displayed on an output device 30 such as a video monitor or printer or other appropriate device.

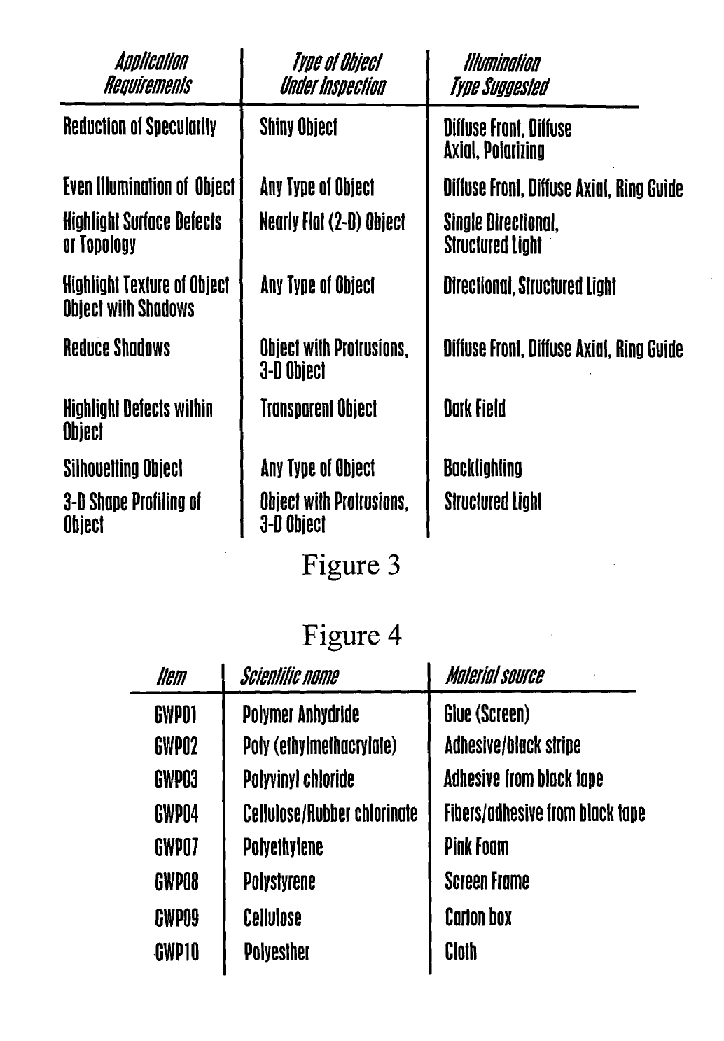

FIG. 3 is a table that divulges various inspection light types (third column of FIG. 3) correlated with respective applications (first column) and types of objects sought to be inspected (second column). Additional information can be found in J. Govier, “Choosing the Correct Illumination”, Edmund Optics 2006 Optics and Optical Instruments Catalogue, vol. N061C, pp. 264-265, incorporated herein by reference. FIG. 4 is a table that correlates contaminant numbers and respective scientific names with potential sources of the contaminants, so that once particular contaminants have been identified using the illumination types of FIG. 3 and classified in accordance with disclosure below by the detector/analyzer assembly 28 of FIG. 2, the source(s) of contaminant(s) can be identified and corrective action taken. As one non-limiting example, if glue is the source of a contaminant it could indicate that over-gluing is being employed during production, indicating retraining or personnel is needed, or that glue containers should be removed from certain locations of the facility, and so on.

As shown in FIG. 3, in non-limiting illustrative implementations, when a reduction of specularity for detecting a shiny contaminant during screen inspection using illuminating light is desired, diffuse front light and/or diffuse axial light and/or polarizing light may be used to illuminate the screen. On the other hand, when even illumination of a contaminant during screen inspection using illuminating light is desired, diffuse front light and/or diffuse axial light and/or a ring guide may be used to illuminate the screen. In contrast, when a highlighting of surface defects of the screen and/or a highlighting of topology during screen inspection using illuminating light is desired, unidirectional light may be used to illuminate the screen. Or, when a reduction of shadows in an image generated during screen inspection using illuminating light is desired, diffuse front light and/or diffuse axial light and/or a ring guide may be used to illuminate the screen. When a highlighting of screen defects during screen inspection using illuminating light is desired, dark field light may be used to illuminate the screen. Still again, when a three dimensional profiling of contaminants during screen inspection using illuminating light is desired, structured light is used.

In a preferred implementation, direct light is directed against a screen 12a to be inspected for contaminants. The screen is visually inspected with the aid of the light to detect contaminants. That is, the present invention recognizes that direct light is generally optimal to inspect the surface of small components, and it is also suitable for inspection of contaminants during assembly of rear projection screens. In one non-limiting implementation, if a contaminant is visually detected a sample of the screen is obtained and analyzed as with spectroscopy as set forth elsewhere herein. In another implementation, the screen is illuminated with high intensity light and the light after interacting with the screen is characterized and classified with spectroscopy analysis to identify contaminants.

As one non-limiting example, the present invention recognizes that a bright spot that appears on a SEM image of a screen during illumination for sample analysis can be caused by a hard particle between the two optical surfaces of the plates of the screen. As another example, the present invention recognizes that a contaminant can scatter inspection light glancingly directed at the screen, and a high intensity glancing illumination over a lenticular lens can be used to identify environmental dust on the screen. Contrast may be improved with a dark background. The small angles between the illumination direction and the surface of the screen plate being inspected avoid the glare produced by the reflection of the optical surface, with small particles scattering the light, allowing to the observer to see the contaminant. In yet another example, scratches are best detected using diffused inspection light as opposed to glancing illumination.

Accordingly, some of the variables to take into consideration when selecting the type of illuminating light for inspection and/or analysis include the direction and angle of illumination, and the light intensity. In the case of large size rear projection screens, a balance typically is struck between the intensity, the inspection area and the working temperature. For example, if it is desired to illuminate a big area with high intensity illumination, a light source with sufficient power must be used, with the concomitant large wattage increasing room temperature and thus requiring in turn an adequate cooling system in order to achieve a comfortable operating area.

In using FIG. 4 to identify sources of contaminants in a production facility it is first necessary, as mentioned above, to determine the morphology and the composition of contaminants. The morphology of a contaminant particle (that, e.g., might have been visually discovered on the screen and removed therefrom during screen illumination) can be identified using optical and/or scanning electronic microscopy, as also discussed above. The material composition can be identified by Fourier Transform Infrared (FTIR) techniques and/or by EDX3 techniques.

Accordingly, the analyzer assembly 28 shown in FIG. 2 may include a FTIR apparatus in which light is directed toward a test sample such as a contaminant. Some of the infrared radiation is absorbed by the sample and some of it is passed through (transmitted). The resulting spectrum, digitized and then Fourier-transformed by a processor in the analyzer, represents the molecular absorption and transmission, creating a molecular fingerprint of the sample. Among the detailed techniques that may be used are transmission spectroscopy (TS), emission spectroscopy (ES), internal reflection spectroscopy (IRS), external reflection spectroscopy (ERS), diffuse reflectance spectroscopy (DRS) and photoacoustic spectroscopy (PAS).

Once the spectrum of a particle is obtained, to complete the generation of FIG. 4 samples can be taken from a suspect material and its spectrum obtained and compared it with the analyzed particle spectrum. Alternatively, the analyzer assembly 28 may be provided with a database of spectrums of known materials. The software can search the database and suggest spectrums that match the obtained spectrum from the sample.

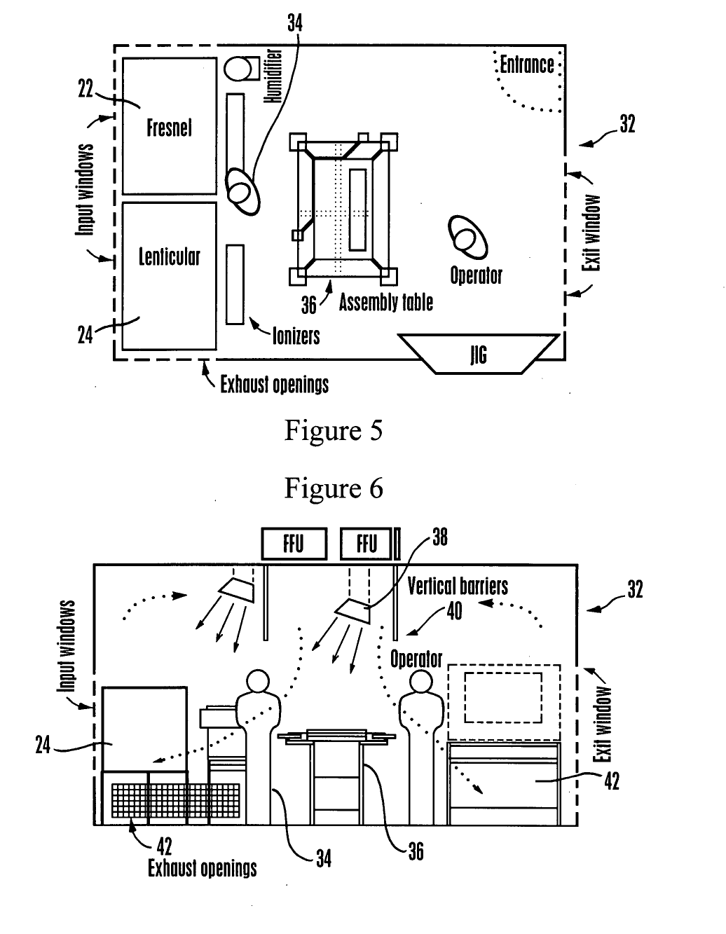

FIGS. 5 and 6 show a non-limiting screen assembly room 32. In overview, to assemble the screen 12 prior to engaging it with the remainder of the TV assembly shown in FIG. 1, the two plates 22, 24, which typically are received at the production facility in separate containers, are removed from their containers in the assembly room 32, with one and only one assembly room being provided per assembly line in one non-limiting embodiment. Each plate 22, 24 initially is stacked on other like plates on respective plate tables. Each plate 22, 24 may be individually cleaned if desired prior to assembly using one or more of the techniques described below.

More specifically, an operator 34, preferably wearing gloves, lifts a (preferably lenticular) plate 22, preferably by the edges, onto an assembly table 36 that is centrally located in the room 32. A Fresnel lens plate 24 can then be positioned vertically along one of the edges of the lenticular plate and an air gun used to direct air against the plates 22, 24 simultaneously to clean the plates. As understood herein, while the lenticular lens plate 22 is amenable to being cleaned by subsequent wiping, the more delicate Fresnel lens plate 24 is not, and so orienting the Fresnel plate 24 vertically during air gun cleaning promotes contaminant removal more so than if the Fresnel lens plate were air cleaned in a horizontal orientation.

After cleaning the Fresnel lens plate 24 is positioned flush against the first plate on the assembly table and the edges of the plates taped together using, e.g., black tape. The screen may then be placed in an inspection chassis and visually inspected using the illuminating light principles disclosed above and any detected contaminants removed using the below-described techniques. Also, if desired the analyzer assembly 28 may be used to classify any contaminants to identify potential sources for corrective action.

Several mechanisms may be used to clean the plates 22, 24. Mechanical methods include scrubbing, the use of abrasives, shear forces applied by fluids, the use of ultrasonic energy to activate solvents, and adhesive films. Direct chemical methods include detergent action, solvent extraction, and the action of acids and alkalis.

### 1) Mechanical Abrasion and Scrubbing

Optical materials such as plastic, glass or crystals, specially coated elements, should not be cleaned as a matter of routine but only when it has been determined that cleaning is required. Mechanical cleaning of any sort applied to a finished optical element can expose the bare material to possible damage. It is preferred to use a dry lens tissue, cotton-tipped swab or soft cloth; however, this may expose the element to scratching. To minimize scratching fluid such as water can be used to lubricate the cloth and to form a boundary layer. Acetone, alcohol, ethanol, and other solvents can also be used to provide a wet surface and to introduce a solvent action over the contaminant, but care must be taken to avoid damage and degradation to the lens by means of the solvent agent.

### 2) Cleaning by Viscous Drag

A shear force may be applied to a small particle by directing a high velocity fluid steam across a surface. The higher the fluid density and the relative velocity, the greater the drag force that can be imparted. High pressure spraying may be advantageous for cleaning optics if sufficient precautions are taken to assure complete drying. Organic solvents evaporate rapidly enough but can cause a cooling of the optical element being cleaned, and if the surface temperature drops below the dew point of the surrounding atmosphere, water molecules will condense and spot the optical surface. To prevent these kinds of problems, dry ionized air forced from a brush air gun can be used.

### 3) Adhesive Films

Several adhesive films are commercially available which may be used to protect and clean optical surfaces. Flexible collodion (i.e. cellulose derivatives) and Strip Coat are two examples of this type of product. They are easily applied by dipping or brushing and may be removed after drying by peeling the film from the surface. During drying the adhesive film entraps most particles on the optical surface and retains them when the film is peeled off. However, incomplete removal of the film due to local tearing must be avoided. Also, further cleaning of the surface may be required to remove the thin layer of plasticizer or organic matter that may be left by the film.

An additional use for these materials is as a coating to reduce atmospheric attack during storage and as a mechanical protective layer against improper handling.

Ordinary tape can be used for taking out particles from optical surfaces if special attention is taken. When glue from tape makes contact with the particle, contact with the optical surface should be avoided.

As shown best in FIG. 6, in the preferred implementation of the assembly room 32 a ventilation unit 38 such as a blower fan is disposed directly vertically above the assembly table 36, and a vertically-oriented barrier 40 that can be a cylinder depends down from the ceiling and is spaced laterally beyond the ventilation unit 38. The barrier 40 may surround the ventilation unit. With the cooperation of structure shown in FIG. 6, the ventilation unit 38 can blow air past the assembly table 36 and into exhaust ports 42 that may exhaust to outside the room 32 or that may be intakes for air filters such as HEPA filters. The exhaust ports 42 may be located near the floor of the room 32 as shown and laterally spaced from the assembly table 36. The vertical barrier 40 protects the table 32 (and lens plates that are disposed thereon) from return air that has not entered the filters. Also, the positive air pressure caused when a blower fan is used as the ventilation unit 38, in cooperation with the air flow inside the room 32 illustrated by the dotted arrow lines, helps to keep contaminated air away from the table 32.

To further promote the avoidance of contamination of the lens plates 22, 24 by operator contact, FIG. 7 shows that corner pads 44 may be provided on respective corners of the assembly table 36. The lens plates rest on the corner pads 44 as shown and on the center of the table 36, with the height of the corner pads preferably equaling the height of the center of the table to minimize bending of the plates 22, 24.

As shown in the detail view in FIG. 7, each corner pad 44 may include a respective central cavity 46 that is located such that when a lens plate is positioned on the table 36, respective corners of the plate are disposed on respective pads 44 without completely covering the cavities 46 of the pads, such that a person can place his fingers in one or more cavities 46 and lift the plate from the table 36. In one implementation, each pad 44 may include a parallelepiped-shaped base 48 supporting a top 50 that can be glued to the base. The top 50 may be a parallelepiped-shaped plate as shown that is identical to the base 48 in size and shape except that an inner square corner quarter of the top 50 is removed, as is a central cylindrical area to form the cavity 46. The corner of the lens plate rests on the base 48 within the removed quarter of the top 50, which helps to align the plates and prevent movement of the plates during taping together.

While the particular SYSTEMS AND METHODS FOR REDUCING DEFECTS DURING ASSEMBLY OF REAR PROJECTION TV SCREENS is herein shown and described in detail, it is to be understood that the subject matter which is encompassed by the present invention is limited only by the claims.

What is claimed is:

1. A method for making a rear projection TV screen, comprising:
prior to engaging the screen with a TV assembly to be vended, illuminating the screen using inspection light;
with the aid of the inspection light identifying contaminants thereon;
removing at least some contaminants from the screen; and
engaging the screen with a TV assembly to be vended.

2. The method of claim 1, comprising establishing air flow in an assembly room in which the screen is disposed to reduce the potential for contaminants to rest on the screen.

3. The method of claim 1, wherein the screen includes first and second lens plates positioned substantially flush against each other.

4. The method of claim 3, wherein the first lens plate is a lenticular lens plate and the second lens plate is a Fresnel lens plate.

5. The method of claim 1, comprising using spectroscopy analysis of the light to identify contaminants on the screen.

6. A method for reducing contamination of TV screens during TV production in a facility, comprising:
prior to engaging a TV screen with a TV assembly, illuminating the screen with light;
inspecting the screen to identify at least one contaminant;
analyzing the contaminant to identify its composition;
correlating the composition to a source of contaminants; and
taking corrective action related to the source of contaminants to reduce the risk of contamination of TV screens in the facility.

7. The method of claim 6, wherein reduction of specularity for a shiny contaminant during the step of illuminating is desired, and diffuse front light and/or diffuse axial light and/or polarizing light is used to illuminate the screen.

8. The method of claim 6, wherein even illumination of a contaminant during the step of illuminating is desired, and diffuse front light and/or diffuse axial light and/or a ring guide is used to illuminate the screen.

9. The method of claim 6, wherein a highlighting of surface defects of the screen and/or a highlighting of topology during the step of illuminating is desired, and unidirectional light is used to illuminate the screen.

10. The method of claim 6, wherein a reduction of shadows in an image generated during the step of illuminating is desired, and diffuse front light and/or diffuse axial light and/or a ring guide is used to illuminate the screen.

11. The method of claim 6, wherein a highlighting of screen defects during the step of illuminating is desired, and dark field light is used to illuminate the screen.

12. The method of claim 6, wherein a three dimensional profiling of contaminants during the step of illuminating is desired, and structured light.

13. A TV production facility comprising:
at least one assembly table configured for juxtaposing first and second TV lens plates;
at least one ventilation unit disposed directly vertically above the table; and
at least one vertically-oriented barrier depending down from a ceiling and spaced laterally beyond the ventilation unit.

14. The facility of claim 13, wherein the barrier is cylindrical and surrounds the unit.

15. The facility of claim 13, wherein the ventilation unit is a fan.

16. The facility of claim 13, wherein the fan blows air past the table and toward at least one exhaust port.

17. The facility of claim 13, comprising corner pads on respective corners of the table, the lens plates resting on the corner pads.

18. The facility of claim 17, wherein each corner pad includes a central cavity located such that when a lens plate is positioned on the table, respective corners of the plate are disposed on respective pads without completely covering the cavities of the pads.

19. The facility of claim 13, wherein the first lens plate is a lenticular lens plate and the second lens plate is a Fresnel lens plate.
